(19) United States
(12) Patent Application Publication
(10) Pub. No.: US 2004/0231441 A1
(43) Pub. Date: Nov. 25, 2004

(54) Structure for oxygen sensor of vehicles

(75) Inventor: Jing-Rong Wu, Pa Te City (TW)

Correspondence Address: TROXELL LAW OFFICE PLLC, Suite 1404, 5205 Leesburg Pike, Falls Church, VA, 22041, US

(73) Assignee: CERADEX CORPORATION

(21) Appl. No.: 10/443,832

(22) Filed: May 23, 2003

(51) Int. Cl. G01D 21/00; G01N 7/00

(52) U.S. Cl. 73/866.5; 73/23.31

(57) ABSTRACT

The present invention relates to a structure for oxygen sensor of vehicles, having a fixture, a ceramics base, an oxygen sensing device, a ring binder and a pipe shroud, wherein the pair of tenons inside the fixture are inlaid into the ring binder's side fillisters. The ring binder is then rotated to have the tenons fit into the positioning fillisters so as to connect the fixture tightly with the ring binder. Finally, the ring binder is covered by a pipe shroud. With the revolving-to-stuck mechanism implemented on the joints between the fixture and the ring binder, it is convenient to repair or replace bad components during tests without damaging the fixture.

### FIELD OF THE INVENTION

The present invention relates to a structure for oxygen sensor of vehicles whose internal parts could be replaced without having its external fixture being damaged.

### BACKGROUND OF THE INVENTION

As shown in FIGS. 1 and 2, traditional oxygen sensor has its oxygen sensing device 4′ placed behind the bolted connector 1′ and then cover the oxygen sensing device 4′ with an external sleeve 2′ whose one end is connected to the bolted connector 1′ and the other end to a pipe shroud 3′. As the combination of the above components completes, it is necessary to test the whole assembly device. However, in order to get correct testing signal during tests, the joints of the sensor must be welded before testing. In case of any defects found in the sensor, the welded joints must be damaged in order to repair the failure of the sensor. In this case, the assembly being damaged will no longer be reused, thus increases the cost of manufacturing.

In view of such a disadvantage that the oxygen sensor's shell must be damaged in case of any failure found in the sensor during tests, the inventor of the present invention was devoted to finding a solution and accomplished structure for power cord.

### SUMMARY OF THE INVENTION

The main objective for the present invention is to provide a structure for oxygen sensors of vehicles that connects the fixture and the ring binder with revolving connectors before tests, thus saves the external fixture of the sensor from being damaged in case of any defects found during the test and makes it easy to replace or repair the inner components.

In the following, the embodiment illustrated is used to describe the detailed structural characteristics and operation action for the present invention.

### BRIEF DESCRIPTION OF THE DRAWINGS

FIG. 1 is a three-dimensional illustration for deformation of traditional oxygen sensor.

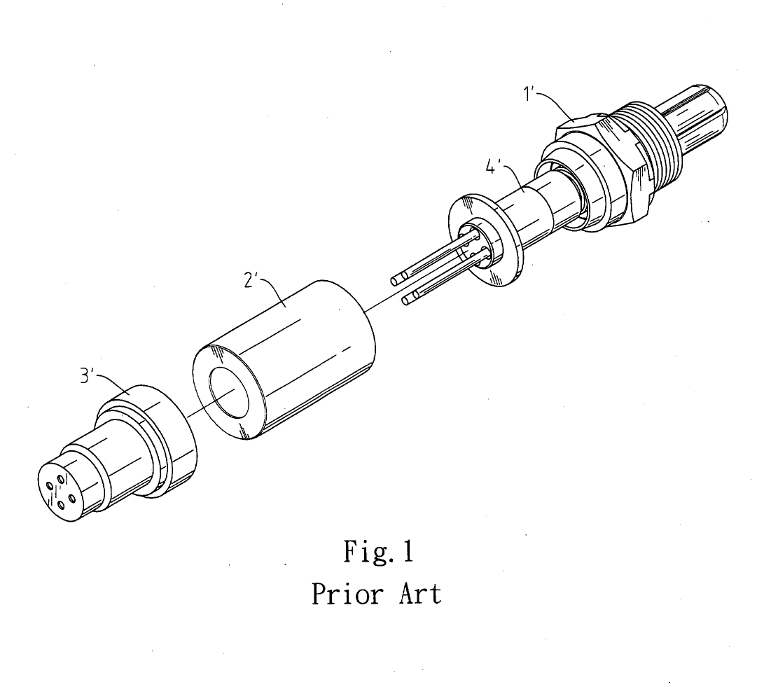

FIG. 2 is a cutaway illustration for assembly of traditional oxygen sensor.

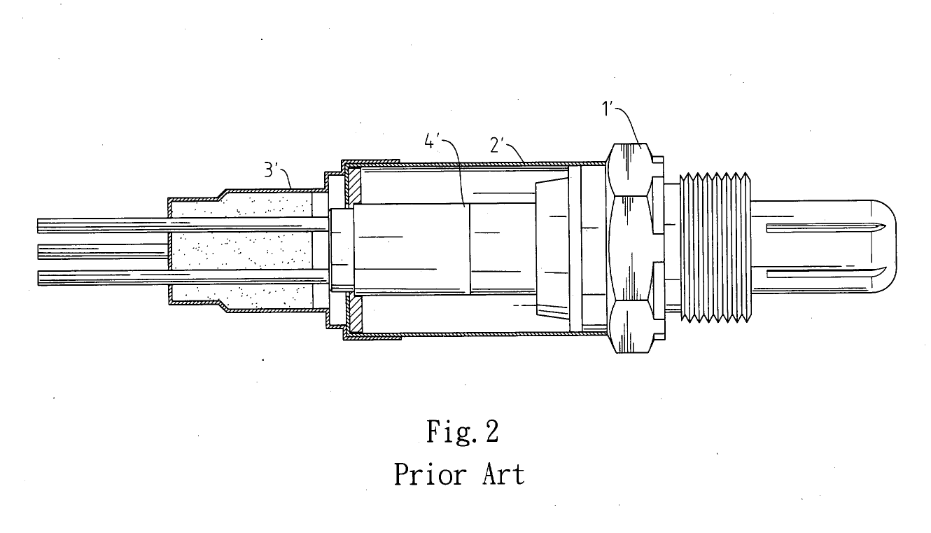

FIG. 3 is a three-dimensional illustration for assembly of the present invention.

FIG. 4 is a three-dimensional illustration for deformation of the present invention.

FIG. 5 is a three-dimensional illustration for partial assembly of the present invention.

FIG. 6 is a cutaway illustration for the present invention.

### DETAILED DESCRIPTION OF THE INVENTION

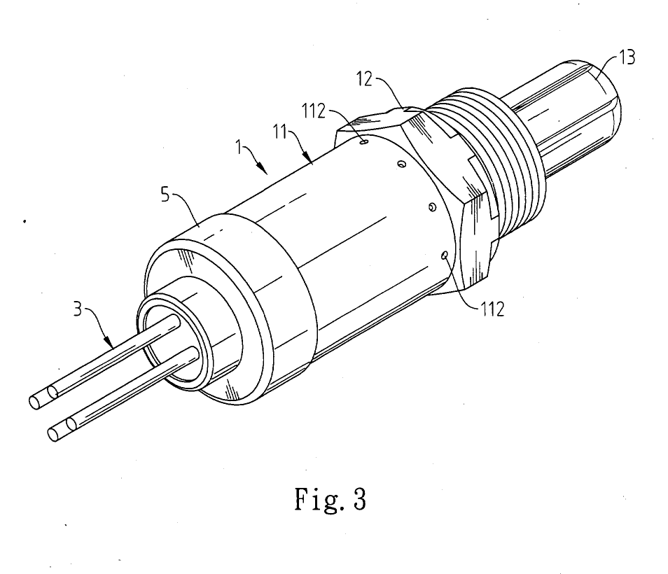

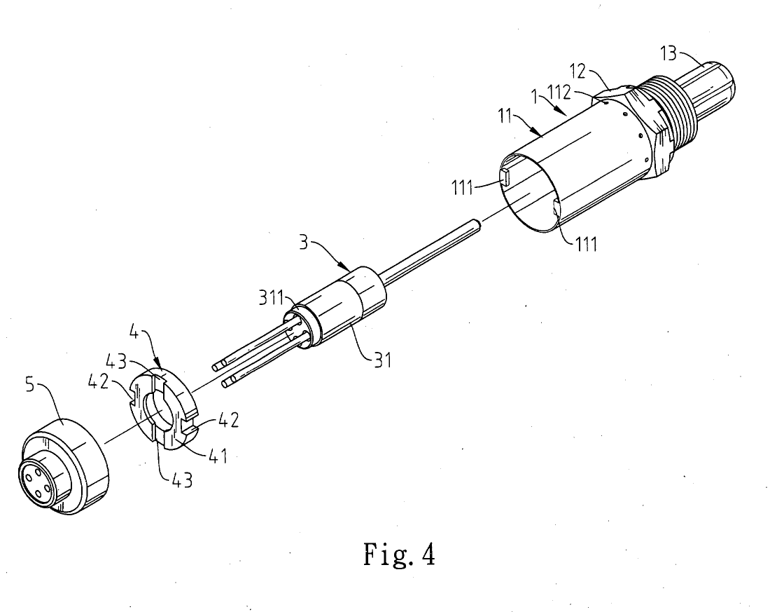

Please refer to FIGS. 3, 4 and 6. The structure for oxygen sensor of the present invention contains a fixture 1, a ceramics base 2, an oxygen sensing device 3, a ring binder 4 and a pipe shroud 5. The fixture 1 whose external sleeve 11 and front sleeve 13 are jointed by bolted connector 12. The bolted connector 12 has an indented ringed groove 121, allowing the external sleeve 11 to fit into the embedded raised points 112 along with the indented ringed groove 121, thus combines the external sleeve 11 with the bolted connector 12.

On the edge of the opening of the external sleeve 11 there is a pair of tenon sitting oppositely to each other. A ceramics base 2 can be placed between the bolted connector 12 and the front sleeve 13 and inside the fixture 1 between the external sleeve 11 and the front sleeve 13 into which the oxygen sensing device 3 to insert. One end of the shell 31 of the oxygen sensing device 3 is connected to the ceramics base 2 while the other end is connected with a ring binder 4. The ring binder 4 is placed at the opening of the external sleeve 11. After placing the ring binder 4 inside the external sleeve 11, a pipe shroud 5 is installed outside the opening of the external sleeve 11 to fasten the internal components.

The above ring binder 4 has a ring plate 41 whose internal diameter is smaller than the body of the ring binder 4, allowing the ring binder 4 to fasten onto the pipe joint 311 of the oxygen sensing device 3, thus fixes the whole assembly.

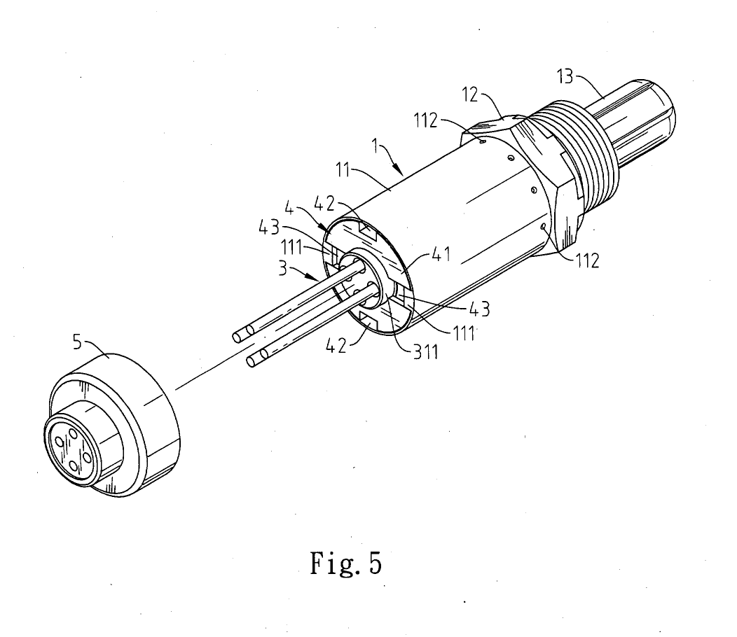

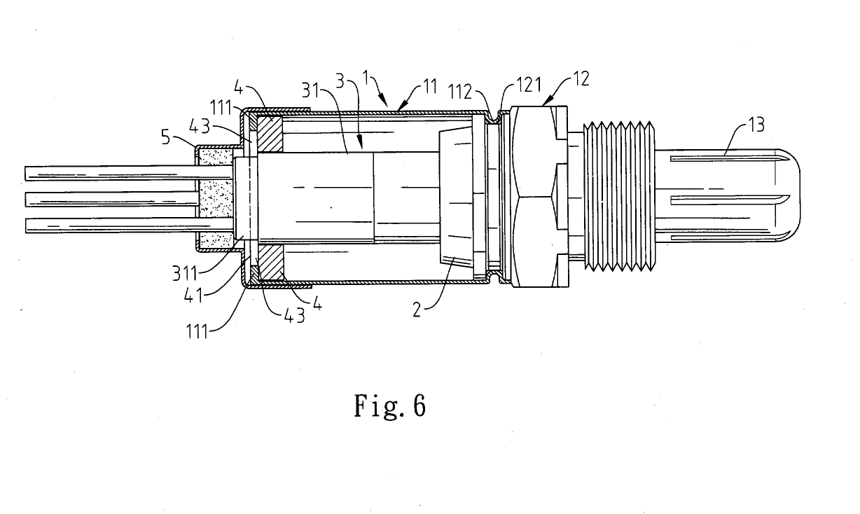

Please refer to FIGS. 5 and 6. There are two sets of side fillisters and positioning fillisters 43 on the ring plate 41, facing against each other. After the components of the oxygen sensing device 3 are located, the test can be implemented. The contact between the ring binder 4 and the fixture 1 must be good enough to get correct signals. Therefore, after placing the ring binder 4 inside the fixture 1, inlay the tenons 111 of the fixture 1 into the side fillisters 42 of the ring binder 4 and then rotate the ring binder to have the tenons fit into the positioning fillisters 43. In this way, the fixture 1 is connected tightly with the ring binder 4, which is then covered by the pipe shroud 5.

Because of the revolving-to-stuck mechanism implemented on the joints between the fixture 1 and the ring binder 4, it is convenient to repair or replace bad components during tests without damaging the fixture 1. Meanwhile, the pipe shroud 5 covered on the fixture 1 and the joint between the external sleeve 11 and the bolted connector 12 can be welded after test completes.

What is claimed is:

1. A structure for O oxygen sensor of vehicles, having a fixture, a ceramics base, an oxygen sensing device, a ring binder and a pipe shroud, wherein a bolted connector joints an external sleeve and a front sleeve of said fixture, a ceramics base is placed between said bolted connector and said front sleeve, inside said fixture between said external sleeve and said front sleeve, said oxygen sensing device is inserted, and a ring binder is placed on one end of said oxygen sensing device, characterized in that:
one end of an external sleeve of said fixture is connected to said bolted connector and the other end has a pair of tenons sitting oppositely against each other;
a ring plate whose internal diameter is smaller than said ring binder is placed on one side of said ring binder, allowing said ring binder to fasten onto a pipe joint of said oxygen sensing device, thus fixes the whole assembly;
after placing said ring binder inside said fixture, said tenons of said fixture are inlaid into side fillisters of said ring binder and then said ring binder is rotated to have said tenons fit into positioning fillisters so as to connect said fixture tightly with said ring binder, and said fixture is then covered by a pipe shroud.

2. The structure for oxygen sensor of vehicles of claim 1, wherein there is an indented ringed groove on surface of said bolted connector, allowing said external sleeve to fit into said embedded raised points along said indented ringed groove, thus combines said external sleeve with said bolted connector.

3. The structure for oxygen sensor of vehicles of claim 1, wherein a ring plate whose internal diameter is smaller than said ring binder is placed on one side of said ring binder, allowing said ring binder to fasten onto a pipe joint of said oxygen sensing device, thus fixes a whole assembly.
